(19) United States
(12) Patent Application Publication
(10) Pub. No.: US 2024/0094490 A1
(43) Pub. Date: Mar. 21, 2024

(54) MINIATURE AND EASY-TO-STRIPPING SQUARE COMMUNICATION OPTICAL CABLE

(71) Applicant: Huizhou Fibercan Industrial Co., Ltd, Huizhou (CN)

(72) Inventor: YAOLE LI, Huizhou (CN)

(21) Appl. No.: 18/133,144

(22) Filed: Apr. 11, 2023

(30) Foreign Application Priority Data
Sep. 19, 2022 (CN) 202222477305.4

(51) Int. Cl. G02B 6/44

(52) U.S. Cl. CPC G02B 6/4432

(57) ABSTRACT

The present application discloses a miniature and easy-to-stripping square communication optical cable, comprises an optical transmission conductor, an optical cable sheath, and a reinforcing component, the optical cable sheath is configured as a cuboid, the optical transmission conductor is arranged at center of the cuboid optical cable sheath, the midpoints of two long sides of the cuboid optical cable sheath are respectively provided with a separation port, and the separation port is configured as isosceles triangle. The optical cable sheath is configured as a cuboid. The midpoints of the two long sides of the cuboid optical cable sheath are respectively provided with an isosceles triangle-shaped separation port, and the apex angles of the isosceles triangle-shaped separation ports are arranged on a second longitudinal centerline.

### CROSS-REFERENCE TO RELATED APPLICATIONS

This application claims the benefit and priority of Chinese patent application No. 202222477305.4, filed on Sep. 19, 2022, disclosure of which is hereby incorporated by reference in its entirety.

### TECHNICAL FIELD

The present application relates to the technical field of communication, in particular to a miniature and easy-to-stripping square communication optical cable.

### BACKGROUND

With the increasing demand for communication bandwidth and the development of mobile communication 5G, the scale of distributed base stations that the communication industry will continue to use will become smaller, faster, and lower cost. At present, the incoming optical cable for communication is divided into the butterfly-shaped lead-in communication optical cable and the circular lead-in communication optical cable. The circular lead-in communication cable is inconvenient to fix and hold. At present, the stripping method for the most of the butterfly-shaped lead-in communication optical cable is to use the stripping tool, that is, the butterfly-shaped cable stripping pliers for stripping. Professional training is required to master the stripping method for the butterfly-shaped lead-in communication optical cable. At the same time, its internal structure is relatively complicated. Most traditional optical cables are stripped by tearing ropes, which is prone to the risk of strangling the optical fiber during the tearing process. There are also some lead-in communication cables with separation ports. For example, [Chinese application] CN202121806277.5 discloses a miniature easy-to-stripping self-supporting lead-in communication cable. This application has separation ports, but the separation points of the separation ports are not concentrated, and it needs to be separated by a cutter first, and then the optical fiber is separated by hand. When the optical fiber is separated by hand alone, the separation port is easy to deviate, which leads to deviation from the separation line, and there is a risk of incomplete stripping of the optical fiber.

### SUMMARY

In order to overcome the deficiencies of the prior art, the present application provides a miniature and easy-to-stripping square communication optical cable.

In order to solve this technical problem, the application proposes: A miniature and easy-to-stripping square communication optical cable, comprises an optical transmission conductor, an optical cable sheath arranged on outer surface of the optical transmission conductor and extending parallel to the optical transmission conductor, and reinforcing components arranged inside the optical cable sheath and respectively arranged on both sides of the optical transmission conductor, the optical cable sheath is configured as a cuboid, and the optical transmission conductor is arranged at center of the cuboid optical cable sheath, the midpoints of two long sides of the cuboid optical cable sheath are respectively provided with a separation port, and the separation port is configured as isosceles triangle, the optical transmission conductor, the optical cable sheath and the reinforcing component are integrally formed.

Further, the cuboid optical cable sheath has a first transverse centerline and a second longitudinal centerline, a center of the reinforcing component and a center of the optical transmission conductor is arranged on the first centerline, and an apex angle of the isosceles triangle separation port is arranged on the second centerline.

Further, the optical transmission conductor comprises a tight sleeve arranged between the two separation ports, an optical fiber arranged in the tight sleeve, the cross sections of the tight sleeve and the reinforcing components are all circular, and a diameter of the tight sleeve is larger than that of the reinforcing component.

Further, a first gap is provided between the reinforcing component and the tight sleeve, and a width of the first gap is smaller than a distance between the reinforcing component and a short side of the cuboid optical cable sheath.

The beneficial effect of the present application is to provide a miniature and easy-to-stripping square communication optical cable. The optical cable sheath is configured as a cuboid, which is convenient for the user to grasp the application and better apply force, and is also more convenient for the application to be fixed during use. The midpoints of the two long sides of the cuboid optical cable sheath are respectively provided with an isosceles triangle-shaped separation port, and the apex angles of the isosceles triangle-shaped separation ports are arranged on a second longitudinal centerline, the user does not need to use the optical cable stripping tool, and can directly tear the optical cable sheath from the isosceles triangle-shaped separation ports with both hands, the stripping method is simple, no need for professional guidance. The optical transmission conductor, the optical cable sheath, and the reinforcing components are integrally formed. The optical cable sheath of the lead-in optical cable protects the optical transmission conductor under normal use and can ensure the protection of the optical transmission conductor during normal tearing, which facilitates production and processing and reduces production costs.

### BRIEF DESCRIPTION OF DRAWINGS

FIG. 1 is a schematic structural diagram of a miniature and easy-to-stripping square communication optical cable according to the present application.

FIG. 2 is a schematic structural diagram of the cross section of a miniature and easy-to-stripping square communication optical cable according to the present application.

### DETAILED DESCRIPTION

Embodiments of the present application will be described below in conjunction with the accompanying drawings and related embodiments. The implementation of the present application is not limited to the following examples, and the relevant necessary components related to the technical field of the present application should be regarded as well-known technologies in the technical field, which are known and mastered by those skilled in the technical field.

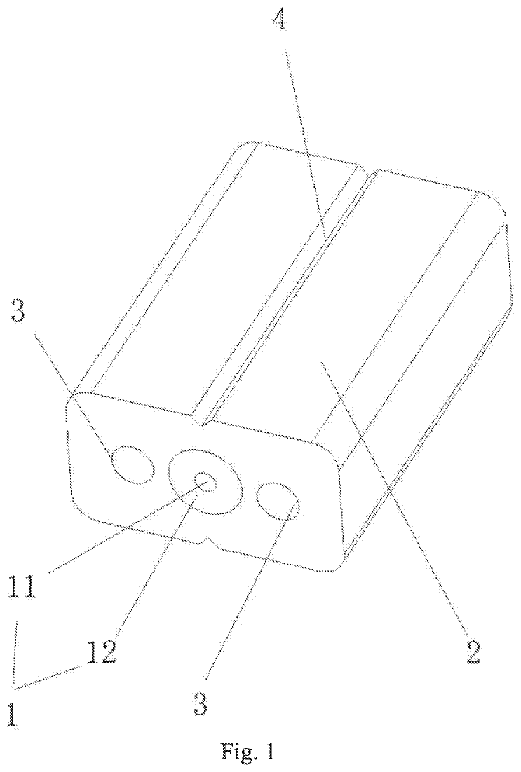

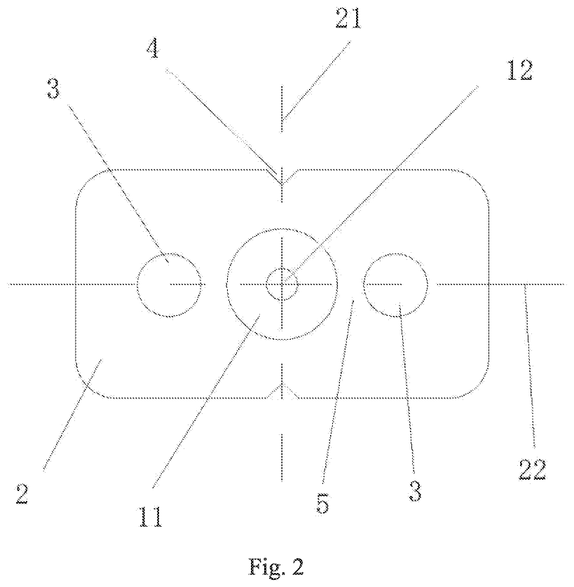

With reference to FIG. 1 to FIG. 2, this application is realized as follows: A miniature and easy-to-stripping square communication optical cable, comprises an optical transmission conductor 1, an optical cable sheath 2 arranged on outer surface of the optical transmission conductor 1 and extending parallel to the optical transmission conductor 1, and reinforcing components 3 arranged inside the optical cable sheath 2 and respectively arranged on both sides of the optical transmission conductor 1, the optical cable sheath 2 is configured as a cuboid, and the optical transmission conductor 1 is arranged at center of the cuboid optical cable sheath 2, the midpoints of two long sides of the cuboid optical cable sheath 2 are respectively provided with a separation port 4, and the separation port 2 is configured as isosceles triangle, the optical transmission conductor 1, the optical cable sheath 2 and the reinforcing component 3 are integrally formed.

The optical transmission conductor 1, the optical cable sheath 2, and the reinforcing components 3 are integrally formed. The optical cable sheath 2 of the lead-in optical cable protects the optical transmission conductor 1 under normal use and can ensure the protection of the optical transmission conductor 1 during normal tearing, which facilitates production and processing and reduces production costs. The optical cable sheath 2 is configured as a cuboid, which is convenient for the user to grasp the application and better apply force, and is also more convenient for the application to be fixed during use. The midpoints of the two long sides of the cuboid optical cable sheath 2 are respectively provided with an isosceles triangle-shaped separation port 4, the user does not need to use the optical cable stripping tool, and can directly tear the optical cable sheath 2 from the isosceles triangle-shaped separation ports 4 with both hands, the stripping method is simple, no need for professional guidance.

On the basis of the above embodiments, as a further preference, the cuboid optical cable sheath 2 has a first transverse centerline 21 and a second longitudinal centerline 22, a center of the reinforcing component 3 and a center of the optical transmission conductor 1 is arranged on the first centerline 21, and an apex angle of the isosceles triangle separation port 4 is arranged on the second centerline 22.

The triangular separation ports 4 are located on the second centerline 22, and the optical cable sheath 2 can be torn away from the triangular separation ports 4 with both hands. The center of the reinforcing component 3 and the center of the optical transmission conductor 1 is arranged on the first centerline 21, the overall structure is stable, it is convenient to hold the optical cable, and the force is uniform during separation to ensure that the separation line is centered, the stripping method is simple, and does not require professional guidance to operate.

On the basis of the above embodiments, as a further preference, the optical transmission conductor 1 comprises a tight sleeve 11 arranged between the two separation ports 4, an optical fiber 12 arranged in the tight sleeve 11, the cross sections of the tight sleeve 11 and the reinforcing components 3 are all circular, and a diameter of the tight sleeve 11 is larger than that of the reinforcing component 3. As a result, the application does not need to increase the cross-sectional area of the sheath, but also has stronger bearing capacity and better tensile strength, so that the application is more suitable for long-distance overhead. When the application is torn by the user, it is easier to bear force, so that the optical cable sheath 2 can be peeled off more easily. At the same time, strengthening the protection of the optical cable sheath 2 to the optical transmission conductor 1 can ensure that the application is suitable for indoors and outdoors.

On the basis of the above embodiments, as a further preference, a first gap 5 is provided between the reinforcing component 3 and the tight sleeve 11, and a width of the first gap 5 is smaller than a distance between the reinforcing component 3 and a short side of the cuboid optical cable sheath 2. As a result, the application does not need to increase the cross-sectional area of the sheath, but also has stronger bearing capacity and better tensile strength, so that the application is more suitable for long-distance overhead.

The above descriptions are only preferred embodiments of the present application. It should be pointed out that those skilled in the art can make some improvements and modifications without departing from the principle of the present application, and these improvements and modifications should also be regarded as the protection scope of the present application.

What is claimed is:

1. A miniature and easy-to-stripping square communication optical cable, comprises an optical transmission conductor (1), an optical cable sheath (2) arranged on outer surface of the optical transmission conductor (1) and extending parallel to the optical transmission conductor (1), and reinforcing components (3) arranged inside the optical cable sheath (2) and respectively arranged on both sides of the optical transmission conductor (1), the optical cable sheath (2) is configured as a cuboid, and the optical transmission conductor (1) is arranged at center of the cuboid optical cable sheath (2), the midpoints of two long sides of the cuboid optical cable sheath (2) are respectively provided with a separation port (4), and the separation port (4) is configured as isosceles triangle, the optical transmission conductor (1), the optical cable sheath (2) and the reinforcing component (3) are integrally formed.

2. The miniature and easy-to-stripping square communication optical cable according to claim 1, wherein the cuboid optical cable sheath (2) has a first transverse centerline (21) and a second longitudinal centerline (22), a center of the reinforcing component (3) and a center of the optical transmission conductor (1) is arranged on the first centerline (21), and an apex angle of the isosceles triangle separation port (4) is arranged on the second centerline (22).

3. The miniature and easy-to-stripping square communication optical cable according to claim 1, wherein the optical transmission conductor (1) comprises a tight sleeve (11) arranged between the two separation ports (4), an optical fiber (12) arranged in the tight sleeve (11), the cross sections of the tight sleeve (11) and the reinforcing components (3) are all circular, and a diameter of the tight sleeve (11) is larger than that of the reinforcing component (3).

4. The miniature and easy-to-stripping square communication optical cable according to claim 1, wherein a first gap (5) is provided between the reinforcing component (3) and the tight sleeve (11), and a width of the first gap (5) is smaller than a distance between the reinforcing component (3) and a short side of the cuboid optical cable sheath (2).
